(19) United States
(12) Patent Application Publication
(10) Pub. No.: US 2012/0204204 A1
(43) Pub. Date: Aug. 9, 2012

(54) Method and Appartus to Perform Real-Time Audience Estimation and Commercial Selection Suitable for Targeted Advertising

(75) Inventors: Michael Kouritzin, Edmonton (CA); Surrey Kim, Edmonton (CA); Jarett Hailes, Edmonton (CA)

(73) Assignee: INVIDI Technologies Corporation, Princeton, NJ (US)

(21) Appl. No.: 13/447,071

(22) Filed: Apr. 13, 2012

Related U.S. Application Data
(63) Continuation of application No. 11/944,078, filed on Nov. 21, 2007, now abandoned.

(51) Int. Cl. H04N 21/442

(52) U.S. Cl. 725/13

(57) ABSTRACT

Input measurements from a measurement device are processed as a Markov chain whose transitions depend upon the signal. The desired information related to the device can then be obtained by estimating the state of the signal at a time of interest. A nonlinear filter system can be used to provide an estimate of the signal based on the observation model. The nonlinear filter system may involve a nonlinear filter model and an approximation filter for approximating an optimal nonlinear filter solution. The approximation filter may be a particle filter or a discrete state filter for enabling substantially real-time estimates of the signal based on the observation model. In one application, a click stream entered with respect to a digital set top box of a cable television network is analyzed to determine information regarding users of the digital set top box so that ads can be targeted to the users.

### CROSS-REFERENCE TO RELATED APPLICATION

This application is a continuation of U.S. patent application Ser. No. 11/944,078, entitled: “METHOD AND APPARATUS TO PERFORM REAL-TIME ESTIMATION AND COMMERCIAL SELECTION SUITABLE FOR TARGETED ADVERTISING,” filed on Nov. 21, 2007. The contents of the above application are incorporated herein as if set forth in full.

### FIELD OF INVENTION

The present invention relates to innovations in nonlinear filtering wherein the observation process is modeled as a Markov chain, as well as utilizing an embodiment of the invention to estimate the user composition of a user equipment device in a communications network, e.g., the number and demographics of television viewers in a digital set top box (DSTB) environment. Furthermore, the present invention provides methods to optimally determine which set of assets, e.g., commercials, to insert into available network bandwidth based on a sampling of optimal conditional estimates of the current network usage (e.g., viewership).

### BACKGROUND OF THE INVENTION

By and large, delivery of commercials to television audiences has changed relatively little over the past fifty years. Marketing firms and advertisers attempt to determine what their target audience watches using historical Nielson™ rating information. This data provides an estimate of the number of households who watched a particular episode of a television show at a particular time, as well as a demographic breakdown (usually based on age, gender, income and ethnicity). Such data (and other rating data) is currently gathered using ‘people meter’ data, which automatically monitors what shows are being watched once a user indicates they are watching television. These samples are relatively small—currently, only approximately 8,000 households are used to estimate the entire viewership across the United States. As the number of available television channels has increased, along with the shift in audience viewership from broadcast to cable television and coupled with the increasing number of television sets within a single household, it is increasingly difficult to accurately estimate the actual audiences of television shows based on such a small sample. As a result, smaller share cable channels are unable to properly estimate their viewership and consequently advertisers are unable to properly capture lucrative target demographics.

As DSTB penetration continues due to the growing demand for digital cable offerings, more precise information for individual households can theoretically be obtained. That is, set top boxes have access to information about what channel is being watched, how long the channel has been watched, and so on. This wealth of information, if properly processed, could provide insight into the behavior of a household. However, none of this information can directly provide the type of information that advertisers wish—what types of people are watching at a particular time. Advertisers want to have their ads displayed to their target audiences with maximum precision, in order to reduce the cost of marketing and increase its effectiveness. Moreover, they wish to avoid the negative publicity cost associated with playing a commercial to inappropriate audiences. The key to providing advertisers with the power to maximize their investment is to change the way viewership is counted, which “potentially [changes] the comparative value of entire genres as well as entire demographic segments” (Gertner, J; Our Ratings, Ourselves; New York Times; Apr. 10, 2005).

Various systems have been proposed or implemented for identifying current viewers or their demographics. Some of these systems have been intrusive, requiring users to explicitly enter identification or demographic information. Other systems have attempted to develop behavioral profiles of viewers based on information from a variety of sources. However, these systems have generally suffered from one or more of the following drawbacks: 1) they focus on who is in the household rather than who is watching now; 2) they may only provide coarse information about a subset of the household; 3) they require user participation, which is undesirable for certain users and may entail error; 4) they do not provide a framework for determining when there are multiple viewers or for accurately defining demographics in multiple viewer scenarios; 5) they are fairly static in their assumptions and do not properly handle changing household compositions and demographics; and/or 6) they employ sub-optimal technologies, require extensive training, require excessive resources or otherwise have limited practical application.

### SUMMARY OF THE INVENTION

The present invention relates to analyzing observations obtained from a measurement device to obtain information about a signal of interest. In one application, the invention relates to analyzing user inputs with respect to a user equipment device of a communications network (e.g., a user input click stream entered with respect to a digital set top box (DSTB) of a cable television network) to determine information regarding the users of the user equipment device (e.g., audience classification parameters of the user or users). Certain aspects of the invention relate to processing corrupted, distorted and/or partial data observations received from the measurement device to infer information about the signal and providing a filter system for yielding, among other things, a substantially real time estimate of the state of the signal at a time of interest. In particular, such a filter system can provide practical approximations of optimized nonlinear filter solutions based on certain constraints on allowable states or combinations therefore inferred from the observation environment.

In accordance with one aspect of the present invention, a method and apparatus (“system”) is provided for developing an observation model with respect to data or measurements obtained from the device under analysis. In particular, the system models the input measurements as a Markov chain, whose transitions depend upon the signal. The observation model may take into account exogenous information or information external to (though not necessarily independent of) the input measurements. In one implementation, the input measurements reflect a click stream of DSTB. The click stream may reflect channel selection events and/or other inputs, e.g., related to volume control. In this case, the observation model may further involve programming information (e.g., downloaded from a network platform such as a Head End) associated with selected channels. In this case, it is the click stream information that is processed as a Markov chain.

Desired information related to the device can then be obtained by estimating the state of the signal at a time of interest. In the example of analyzing a click stream of a DSTB, the signal may represent a user composition (involving one or more users and/or associated demographics) and an additional factor affecting the click stream such as a channel changing regime as discussed in more detail below. Once the signal has been estimated, a state of the signal at a past, present or future time can be determined, e.g., to provide user composition information for use in connection with an asset targeting system.

In accordance with a still further aspect of the present invention, a system generates substantially real time estimates of the probability distribution for a signal state based on both the observations and an observation signal model. In this regard, a nonlinear filter system can be used to provide an estimate of the signal based on the observation model. The nonlinear filter system may involve a nonlinear filter model and an approximation filter for approximating an optimal nonlinear filter solution. For example, the approximation filter may include a particle filter or a discrete state filter for enabling substantially real time estimates of the signal based on the observation model. In the DSTB example, the nonlinear filter system allows for estimates that incorporate user compositions including more than one viewer and adapting to changes in the potential audience, e.g., additions of previously unknown persons or departures of prior users with respect to the potential audience.

In accordance with a further aspect of the present invention, a system uses an estimate obtained by applying a filter, with its associated signal and observation models, to a sequence of observations to obtain information of interest with respect to the signal. Specifically, information for a past, present or future time can be obtained based on an estimated probability distribution of the signal at the time of interest. In the case of analyzing usage of a DSTB, the identity and/or demographics of a user or users of the DSTB at a particular time can be determined from the signal state. This information may be used, for example, to “vote” or identify appropriate assets for an upcoming commercial or programming spot, to select an asset from among asset options for delivery at the DSTB and/or to determine or report a goodness of fit of a delivered asset with respect to the user or users who received the asset.

The above noted aspects of the invention can be provided in any suitable combination. Moreover, any or all of the above noted aspects can be implemented in connection with a targeted asset delivery system.

In one embodiment of the present invention, a system is provided for use in targeting assets to users of user equipment devices in a communications network, for example, a cable television network. The system involves: developing an observation model based on inputs (e.g., click stream data) by one or more users with respect to a user equipment device (e.g., a DSTB); modeling the signal as reflective of at least a user composition of one or more users of said user equipment device with respect to time; determining the likelihood of various user compositions at a time of interest among possible states of the signal; and using the estimated user composition in targeting an asset for the user equipment device. In this manner, filtering theory is applied with respect to inputs, such as a click stream, of a user equipment device so as to yield an estimate indicative of user composition.

The observations (e.g., the inputs) can be modeled as a Markov chain. The model of the signal allows for representation of the user composition as including two or more users. Accordingly, multiple user situations can be identified for use in targeting assets and/or better evaluating audience size and composition (e.g., to improve valuation and billing for asset delivery). In addition, the signal model preferably allows for representation of a change in user composition, e.g., addition or removal of a person from a user audience.

A nonlinear filter may be defined to estimate the signal based on the observation model. In this regard, the signal may model the user composition of a household with respect to time and audience classification parameters (e.g., demographics of one or more current users) can be estimated as a function of the state of the signal at a time of interest. In order to provide a practical estimation of an optimal nonlinear filter solution, an approximation filter may be provided for approximating the operation of the nonlinear filter. For example, the approximation filter may include a particle filter or a discrete space filter as described below. Moreover, the approximation filter may implement at least one constraint with respect to one or more signal components. In this regard, the constraint may operate to treat one component of the signal as invariant with respect to a time period where a second component is allowed to vary. Moreover, the constraint may operate to treat at least one state of a first component as illegitimate or to treat some combination of states of different signal components as illegitimate. For example, in the case of a click stream of a DSTB, the occurrence of a click event indicates the certain presence of at least one person. Accordingly, only user compositions corresponding to the presence of at least one person are permissible at the time of a click event. Other permissible or impermissible combinations may relate incomes to locations. The constraints may be implemented in connection with a finite space approximation filter. For example, values incident on an illegitimate cell may be repositioned, e.g., proportionately moved to neighboring legitimate cells. In this manner, the approximation filter can quickly converge on a legitimate solution without requiring undue processing resources. Where the constraint operates to define at least one potential calculated state as illegitimate, the approximation filter may redistribute one or more counts associated therewith.

Additionally, the approximation filter may be operative to inhibit convergence on an illegitimate state. Thus, the approximation filter is designed to avoid convergence on a user composition for a DSTB that is logically impossible or unlikely (a click event when no user is present) or deemed illegitimate by rule (an income range not permitted for a given location). In one implementation, this is accomplished by adding seed counts to legitimate cells of a discrete space filter to inhibit convergence with respect to an illegitimate cell.

Preferably, the user composition information is processed at the DSTB. That is, user information is processed at the DSTB and used for voting, asset selection and/or reporting. Alternatively, click stream data may be directed to a separate platform, such as a Head End, where the user composition information can be estimated, e.g., where messaging bandwidth is sufficient and DSTB processing resources are limited. As a further alternative, the user composition information (as opposed to, e.g., asset vote information) may be transmitted to a Head End or other platform for use in selecting content for insertion.

The estimated user composition information may be used by an asset targeting system. For example, the information may be provided to a network platform such as a Head End that is operative to insert assets into a content stream of the network. In this regard, the platform may utilize inputs from multiple DSTBs to select assets for insertion into available network bandwidth. Additional information, such as information reflecting the per user value of asset delivery, may be utilized in this regard. The platform may process information from multiple user equipment devices as an observation model and apply an appropriately configured filter with respect to the observation model to estimate an overall composition of a network audience at a time of interest.

In accordance with another aspect of the present invention, stochastic control theory is applied to the problem of asset selection, e.g., selecting the optimal set of commercial assets to communicate through a limited number of advertising insertion channels. Traditionally, stochastic control theory has been applied in contexts where the state of a system is randomly (time) varying and possibly the exact consequences of various controls applied to the system are only known probabilistically.

When one only has noisy, imperfect observations of the system, one must base the set of controls on filtering estimates which are also randomly varying over time. When there are nonlinearities present there is no separation principle to rely on and one must work on a sample path by sample path basis. In the present invention, we do not even get noisy, imperfect observations of the state of the system we want to estimate (i.e., the demographics of the viewers of the various DSTBs), but rather only a noisy partial measurement of the DSTBs estimates of their viewers. Hence, we take the novel approach of designing our system to estimate the set of conditional probability distributions of the DSTBs, from which audience estimates can be obtained as a two-step procedure. We adapt our stochastic control procedures to handle this more general setting.

In the present context, sampled viewer estimates from DSTBs received at the Head End are taken to be observations of the system of probability distributions over household viewing states, of arriving advertising contracts, and of ad sale and delivery, in order to allow control decisions regarding which contracts with advertisers to accept. Stochastic control is used to optimize some utility function of the system, e.g., stable profitability.

### BRIEF DESCRIPTION OF THE DRAWINGS

For a more complete understanding of the present invention and further advantages thereof, reference is now made to the following detailed description, taken in conjunction with the drawings in which:

FIG. 1 is a schematic diagram of a targeted advertising system in accordance with the present invention;

FIG. 2 illustrates the REST structure in accordance with the present invention;

FIG. 3 illustrates a cell structure for a cell of a discrete space filter in accordance with the present invention;

FIG. 4 is a flowchart illustrating a filter evolution process in accordance with the present invention; and

FIG. 5 is a block diagram illustrating a process for simulating events in accordance with the present invention.

### DETAILED DESCRIPTION

In the following description, the invention is set forth in the context of a targeted asset delivery (e.g., targeted advertising) system for a cable television network, and the invention provides particular advantages in this context as described herein. However, it will be appreciated that various aspects of this invention are not limited to this context. Rather, the scope of the invention is defined by the claims set forth below.

Various targeted advertising systems for cable television networks have been proposed or implemented. These systems are generally predicated on understanding the current audience composition so that commercials can be matched to the audience so as to maximize the value of the commercials. It will be appreciated that a variety of such systems could benefit from the structure and functionality of the present invention for identifying classification parameters (e.g., demographics) of current viewers. Accordingly, although a particular targeted asset delivery system is referenced below for purposes of illustration, it will be appreciated that the invention is more broadly applicable.

One targeted asset delivery system, in connection with which the present invention may be employed, is described in the above-noted U.S. patent application Ser. No. 11/331,835, filed Jan. 12, 2006. In the interest of brevity, the full detail of that system is not repeated herein. Generally, in that system, multiple asset options are provided for a given time spot on a given programming channel. Although various types of assets can be targeted in this regard as set forth in that description, targeted advertising (e.g., targeting of commercials) is an illustrative application and is used as a convenient shorthand reference herein. Thus, a given programming channel may be supported by multiple asset (e.g., ad) channels that provide ad options for one or more ad spots of a commercial break. A DSTB operates to invisibly (from the perspective of the viewer) switch to appropriate ad channels during a commercial break to provide targeted advertising to the current viewer(s).

The viewer identification structure and functionality of the present invention can be used in the noted targeted asset delivery system in a variety of ways. In the noted system, an ad list including targeting parameters is sent to DSTBs in advance of a commercial break. The DSTB determines classification parameters for a current viewer or viewers, matches those classification parameters to the targeting parameters for each ad on the list and transmits a “vote” for one or more ads to the Head End. The Head End aggregates votes from multiple DSTB and assembles an optimized flotilla of ads into the available bandwidth (which may include the programming channel and multiple ad channels). At the time of the commercial break, the DSTB selects a “path” through the flotilla to deliver appropriate ads. The DSTB can then report what ads were delivered together with goodness of fit information indicating how well the actual audience matched the targeting parameters.

The present invention can be directly implemented in the noted targeted asset delivery system. That is, using the technology described herein, the audience classification parameters for the current viewer(s) can be estimated at the DSTB. This information can be used for voting, ad selection and/or goodness of fit determinations as described in the noted pending application. Alternatively, the description below describes a filter theory based Head End ad selection system that is an alternative to the noted voting processes. As a still further alternative, click stream information can be provided to the Head End, or another network platform, where the audience classification parameters may be calculated. Thus, the audience classification parameter, ad selection and other functionality can be varied and may be distributed in various ways between the DSTBs, Head End or other platforms.

The following section is broken into several parts. In the first part, some background discussion of the relevant nonlinear filter theory is provided. In the second part, the architecture and model classes are discussed.

1.1 Nonlinear Filtering

To properly solve the targeted advertisement viewership (potential and current) problem, one may look to the mathematically optimal field of filtering.

1.1.1 Traditional Nonlinear Filtering Overview

Nonlinear filtering deals with the optimal estimation of the past, present and/or future state of some nonlinear random dynamic process (typically called ‘the signal’) in real-time based on corrupted, distorted or partial data observations of the signal. In general, the signal Xₜ is regarded as a Markov process defined on some probability space (Ω, ℑ, P) and is the solution to some Martingale problem. The observations typically occur at discrete times tₖ and are dependent upon the signal in some stochastic manner using a sensor function Yₖ=h(Xₜ_{ₖ}, Vₖ). Indeed, the traditional theory and methods are built around this type of observations, where the measurements are distorted (by nonlinear function h), corrupted (by noise V), partial (by the possible dependence of h on only part of the signal's state) samples of the signal. The optimal filter provides the conditional distribution of the state of the signal given the observations available up until the current time:

P(Xₜεdx|σ{Yₖ,0≦tₖ≧t})

The filter can provide optimal estimates for not only the current states of the signal but for previous and future states, as well as path segments of the signal:

P(X_{[t}_{ᵣ}_{,t}_{ₛ}_{]}εdx|σ{Yₖ,0≦tₖ≧t})

where 0≦tᵣ≦tₛ<∞.

In certain linear circumstances, an effective optimal recursive formula is available. Suppose the signal follows a “linear” stochastic differential equation dXₜ=AXₜdt+BdWₜ, with A being a linear operator, B being a fixed element and W being a Brownian motion. Furthermore, the observation function takes the form of Yₖ=CXₜ_{ₖ}+Vₖ where {Vₖ}ₖ₌₁^{∞} are independent Gaussian random variables and C is a linear operator. This formula is known as the Kalman filter. While the Kalman filter is very efficient in performing its estimates, its use in applications is inherently limited due to the strict description of the signal and observation processes. In the case where the dynamics of the signal are nonlinear, or the observations have non-additive and/or correlated noise, the Kalman filter provides sub-optimal estimates. As a result, other methods are sought out to provide optimal estimates in these more common scenarios.

While equations for optimal nonlinear estimation have been available for several decades, until recently they were found to be of little use. The optimal equations were unimplementable on a computer, requiring infinite memory and computational resources to be used. However, in the past decade and a half, approximations to the optimal filtering equations have been created to overcome this problem. These approximations are typically asymptotically optimal, meaning that as an increasing amount of resources are used in their computation they converge to the optimal solution. The two most prevalent types of such methods are particle methods and discrete space methods.

1.1.2 Particle Filters

Particle filtering methods involve creating many copies of the signal (called) ‘particles’) denoted as {ξₜ^{j}}ⱼ₌₁^{N}^{₁}, where Nₜ is the number of particles being used at time t. These particles are evolved independently over time according to the signal's stochastic law. Each particle is then assigned a weight value W_{1,m}(ξₜ^{j}) to effectively incorporate the information from the sequence of observations {Y₁, . . . , Yₘ}. This can be done in such a way that the weight after m observations is the weight after m−1 multiplied by a factor dependent on the m^{th} observation Yₘ. However, these weights invariably become extremely uneven meaning that many particles (those with relatively low weights) become unimportant and do little other than consume computer cycles. Rather than only removing these particles and reducing calculation to an ever-decreasing number of particles, one resamples the particles, which means the positions and weights of particles are adjusted to ensure that all particles contribute to the conditional distribution calculation in a meaningful way while ensuring that no statistical bias is introduced by this adjustment. Early particle methods tended to resample far too extensively, introducing excessive resampling noise into the system of particles and degrading estimates. Suppose that after resampling the weights of the particles after m observations are denoted as \tilde{W}_{1,m}{ξₜ^{j}}ⱼ₌₁^{N}^{₁}. Then, the particle filter's approximation to the optimal filter's conditional distribution is:

$$P ( {X}_{t} ∈ A \vert {Y}_{1} , … , {Y}_{m} ) \approx \frac{{\sum }_{j = 1}^{{N}_{{t}_{m}}} {\tilde{W}}_{1 , m} ( {ξ}^{j} ) {1}_{{ξ}_{tm}^{j} ∈ A}}{{\sum }_{j = 1}^{{N}_{{t}_{m}}} {\tilde{W}}_{1 , m} ( {ξ}^{j} )}$$

As N^{t}→∞, the particle-filtering estimate yields the optimal nonlinear filter estimate.

An improvement that introduced significantly less resampling degradation and improved computational efficiency was introduced in U.S. Pat. No. 7,058,550, entitled “Selectively Resampling Particle Filter,” which is incorporated herein by reference. This method performed pair-wise resampling as follows:

1. While \tilde{W}_{1,m}(ξ^{j})<p\tilde{W}_{1,m}(ξⁱ) for the highest weighted particle j and the lowest weighted particle i, then:

2. Set the state of particle i to j with probability

$$\frac{{\tilde{W}}_{1 , m} ( {ξ}^{j} )}{{\tilde{W}}_{1 , m} ( {ξ}^{j} ) + {\tilde{W}}_{1 , m} ( {ξ}^{i} )}$$

and set the state of particle j to i with probability

$$\frac{{\tilde{W}}_{1 , m} ( {ξ}^{j} )}{{\tilde{W}}_{1 , m} ( {ξ}^{j} ) + {\tilde{W}}_{1 , m} ( {ξ}^{i} )} .$$

3. Reset the weight of particles i and j to

$${\tilde{W}}_{1 , m} ( {ξ}^{j} ) = {\tilde{W}}_{1 , m} ( {ξ}^{i} ) = \frac{{\tilde{W}}_{1 , m} ( {ξ}^{j} ) + {\tilde{W}}_{1 , m} ( {ξ}^{i} )}{2} .$$

In this method, a control parameter ρ is introduced to appropriately moderate the amount of resampling performed. As described in U.S. Pat. No. 7,058,550, this value can be dynamic over time in order to adapt to the current state of the filter as well as the particular application. This filing also included efficient systems to store and compute the quantities required in this algorithm on a computer.

1.1.3 Discrete Space Filters

When the state space of the signal is on some bounded finite dimensional space, then a discrete space and amplitude approximation can be used. A discrete space filter is described in detail in U.S. Pat. No. 7,188,048, entitled “Refining Stochastic Grid Filter” (REST Filter), which is incorporated herein by reference. In this form, the state space D is partitioned into discrete cells η_{c} for c in some finite index set C. For instance, this space D could be a d-dimensional Euclidean space or some counting measure space. Each cell yields a discretized amplitude known as a “particle count” (denoted as n^{η}^{_{c}}), which is used to form the conditional distribution of the discrete space filter:

$$P ( {X}_{t} ∈ A \vert {Y}_{1} , … , {Y}_{m} ) \approx \frac{{\sum }_{c ∈ C} {n}^{{η}_{c}} {1}_{{η}_{c} ∈ A}}{{\sum }_{c ∈ C} {n}^{{η}_{c}}}$$

The particle counts of each state cell are altered according to the signal's operator as well as the observation data that is processed. As the number of cells becomes infinite, then the REST filter's estimate converges to the optimal filter. To be clear, this filing considers directly discretizing filtering equations rather than discretizing the signal and working out an implementable filtering equation for the discretized signal.

In U.S. Pat. No. 7,188,048, the invention utilized a dynamic interleaved binary index tree to organize the cells with data structures in order to efficiently recursively compute the filter's conditional estimate based on the real-time processing of observations. While this structure was amenable to certain applications, in scenarios where the dimensional complexity of the state space is small, the data structure's overhead can reduce the method's utility.

1.2 Stochastic Control

To properly solve the targeted commercial selection problem, one should look to the mathematically optimal field of stochastic control.

Conceptually, one could invent particle methods or direct discretization methods to solve a stochastic control problem approximately on a computer. However, these have not yet been implemented or at least widely recognized. Instead, implementation methods usually discretize the whole problem and then solve the discretized problem.

2.1 Targeted Advertising System Architecture

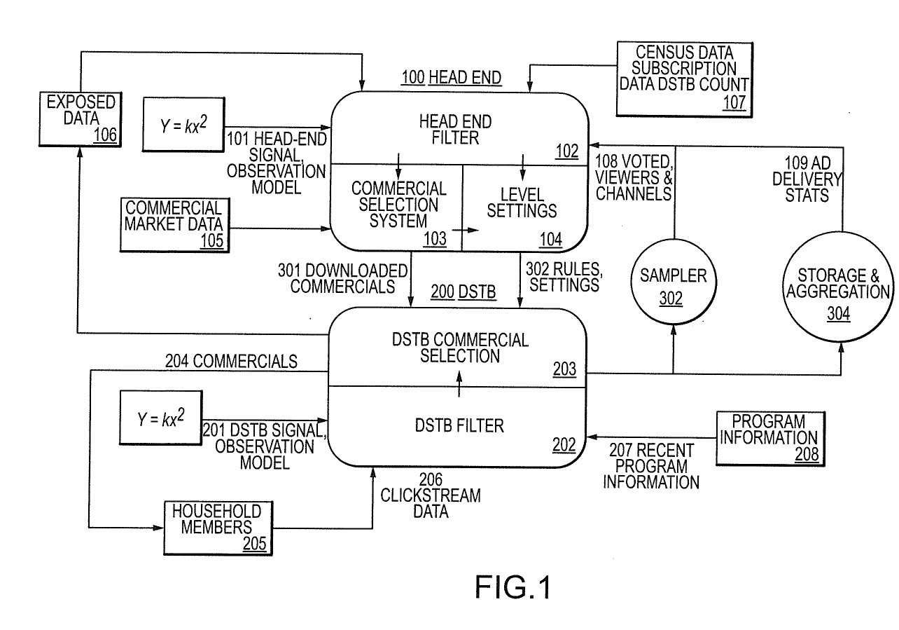

FIG. 1 depicts the overall targeted advertising system. The system is composed of a Head End 100 and one or more DSTBs 200. The DSTBs 200 are attempting to estimate the conditional probability of the state of potential viewers in household 205, including the current member(s) of the household watching television, using the DSTB filter 202. The DSTB filter 202 uses a pair of models 201 describing the signal (household) and the observations (the click stream data 206). The DSTB filter 202 is initialized via the setting 302 downloaded from the Head End 100. To estimate the state of the household the DSTB filter 202 also uses program information 207 (which may be current, or in the recent past or future), which is available from a store of program information 208.

The DSTB filter 202 passes its conditional distribution or estimates derived thereof to a commercial selection algorithm 203, which then determines which commercials 204 to display to the current viewers based on the filter's output, the downloaded commercials 301, and any rules 302 that govern what commercials are permissible given the viewer estimates. The commercials displayed to the viewers are recorded and stored.

The DSTB filter 202 estimates, as well as commercial delivery statistics and other information, may be randomly sampled 303 and aggregated 304 to provide information to the Head End 100. This information is used by a Head End filter 102, which computes (subject to its available resources) the conditional distribution for the aggregate potential and actual viewership for the set of DSTBs with which it is associated. The Head End filter 102 uses an aggregate household and DSTB feedback model 101 to provide its estimates. These estimates are used by the Head End commercial selection system 103 to determine which commercials should be passed to the set of DSTBs controlled by the Head End 100. The commercial selection system 103 also takes into account any market information 105 available concerning the current commercial contracts and economics of those contracts. The resulting commercials selected 301 are subsequently downloaded to the DSTBs 200. The commercials selected for downloading affect the level settings 104, which provide constraints on certain commercials being shown to certain types of individuals.

The following two sections describe certain detail elements of this system.

2.2 Household Signal and Observation Model Description

In this section, the general signal and observation model description are given as well as examples of possible embodiment of this model.

2.2.1 Signal Model Description

In general, the signal of a household is modeled as a collection of individuals and a household regime. In one preferred embodiment, this household represents the people who could potentially watch a particular television that uses a DSTB. Each individual (denoted as Xⁱ) at a given point in time t has a state from the state space s ε S, where S represents the set of characteristics that one wishes to determine for each person within a household. For example, in one embodiment one may wish to classify the age, gender, income, and watching status of each individual. In addition, it has been found that certain behavioral information, in particular, the amount of television watched by each individual, is useful in developing and using classifications. Age and income may be considered as real values, or as a discrete range. In this example, the state space would be defined as:

S={0−12,12−18,18−24,24−38,38+}×{Male,Female}×{0−$50,000,$50,000+}×{Yes,No}

The household member tuple is then

$${⋃}_{k = 0}^{∞} {S}^{k} ,$$

where k denotes the number of individuals and S⁰ denotes the single state with no individuals. The household member tuple Xₜ=(Xₜ¹ . . . Xₜⁿ^{ₜ}) has a time-varying random number of members, where nₜ is the number of members at time t. Since the order of members within this collection is immaterial to the problem, we use the empirical measure of the members χₜ=Σᵢ₌₁ⁿ^{₁}δχᵢ¹ to represent the household.

The household regime represents a current viewing “mindset” of the household that can materially influence the generation of click stream data. The household's current regime rₜ is a value from the state space R. In one embodiment of the invention, the regimes can consist of values such as “normal,” “channel flipping,” “status checking,” and “favorite surfing.”

Thus, the complete signal is composed of the household and the regime:

χₜ=(χₜ,Rₜ)

which evolves in some state space E.

The state of the signal evolves over time via rate functions λ, which probabilistically govern the changes in signal state. The probability that the state changes from state i to j later than some time t is then:

R_{i→j}^{T}(t)=P(T>t)=exp(−∫₀^{t}λ_{T}(s)ds)

There are separate rate functions for the evolution of each individual, the household membership itself, and the household's regime. In one embodiment of the invention, the rate functions for an individual i depend only on the given individual, the empirical measure of the signal, the current time, and some external environmental variables λ(t, χₜⁱ, χₜ, εₜ).

The number of individuals within the household nₜ varies over time via birth and death rates. Birth and death rates do not merely indicate new beings being born or existing beings dying—they can represent events that cause one or more individuals to enter and exit the household. These rates are calculated based on the current state of all individuals within the household. For example, in one embodiment of the invention a rate function describing the likelihood of a bachelor to have either a roommate or spouse enter the household may be calculated.

In one embodiment of the invention, these rate functions can be formulated as mathematical equations with parameters empirically determined by matching the estimated probability and expected value of state changes from available demographic, macroeconomic, and viewing behavior data. In another embodiment, age can be evolved deterministically in a continuous state space such as [0, 120].

2.2.2 Observation Model Description

In general, the observation model describes the random evolution of the click stream information that is generated by one or more individuals' interaction with a DSTB. In one preferred embodiment of the invention, only current and past channel change information is represented in the observation model. Given a universe of M channels, we have a channel change queue at time tₖ of Yₖ=(yₖ, . . . , Y_{k-B+1}), with B representing the number of retained channel changes, channels that were watched in the past B discrete time steps. In one preferred embodiment of the invention, only the times when a channel change occurs as well as the channel that was changed to are recorded to reduce overhead.

In the more general case, a viewing queue contains this current and past channels as well as such things as volume history. In the aforementioned case, the viewing queue degenerates to the channel change queue.

The probability of the viewing queue changing from state i to state j at time t based on the state of the signal and some downloadable content Dₜ (denoted as p_{i→j}(Dₜ,Xₜ)) is then determined. In one preferred embodiment, this downloadable content contains, among other things, some program information detailing a qualitative category description of the shows that are currently available, for instance, for each show, whether the show is an “Action Movie” or a “Sitcom”, as well as the duration of the show, the start time of the show, the channel the show is being played on, etc.

In the absence of a special regime, an empirical method has been created to calculate the Markov chain transition probabilities. These probabilities are dependent on the current state of all members of the household and the available programs. This method is validated using observed watching behavior and Varadarajan's law of large numbers. Suppose that P is a discrete probability measure, assigning probabilities to Ω=}ω₁, . . . , ω_{K}} and we have N independent copies of the experiment of selecting an element. Then, the law of large numbers says that

$$\frac{1}{N} {\sum }_{i = 1}^{N} {\sum }_{k = 1}^{K} {1}_{{ω}_{k} = {ω}^{i}} ⇒ P ,$$

where ωⁱ is the i^{th} random outcome of drawing an element from Ω.

In one embodiment of the invention, this method focuses on calculating the probabilities for a channel queue of size 1 (i.e., Yₖ=yₖ). The observation probabilities, that is, the probabilities of switching between two viewing queues over the next discrete step, can be first calculated by determining the probability of switching categories of the programs and then finding the probability of switching into a particular channel within that category. The first step is to calculate, often in a offline manner, the relative proportion of category changes that occur due to channel changes and/or changes in programs on the same channel. In order to perform this calculation, the set of all possible member states Xₜ is mapped into a discrete state space Π such that ƒ(Xₜ)=πₜ for some πₜ εΠ for all possible Xₜ. We suppose there are a fixed, finite set of categories C={c₁, c₂, . . . , c_{K}}. Furthermore, let there be N_{ν} viewer records, with each viewer record representing a constant period of time Δt, and with each three-tuple viewing record V (k)=(π, b, c) with k=1,2, . . . , N_{ν} and b, c ε C, containing information about the discretized state of the household (π) and the category at the beginning (b) and the end (c) of the time period. Then, for each π ε II and b, c ε C, we calculate:

$$N ( π , b , c ) = \{ \begin{matrix}{\sum }_{k = 1}^{{N}_{υ}} {1}_{{1}_{v ( k )}} ( π , b , c ) , & b -> c valid this time step , \\ 0 , & otherwise .\end{matrix}$$

When the optimal estimation system is running in real-time, the probabilities for the category transition from cᵢ to cⱼ that occurs at a given time step are calculated first by calculating the probability of category changes given the currently available programs:

$${P}_{{c}_{i} -> {c}_{J}} ( π ) = [ \frac{N ( π , {c}_{i} , {c}_{j} )}{{\sum }_{cx = 1}^{K} N ( π , {c}_{i} , {c}_{α} )}$$

where the summation from α=1 to K accounts for all of the categories in C. Suppose that cᵢ is the category associated with channel i and cⱼ is the category associated with channel j. Then, this probability is converted into the needed channel transition probability by:

$${P}_{i -> j} ( π ) = \frac{{P}_{{c}_{1} -> {c}_{J}} ( π )}{{n}_{t} ( {c}_{j} )}$$

Where nₜ(cⱼ) is the number of channels that have shows that fall in category cⱼ at the end of the current time step.

An alternative probability measure may be calculated by the “popularity” of channels instead of the transition between channels at each discrete time step. This above method can be used to provide this form by simply summing over the transition probabilities for a given category:

$${P}_{{c}_{J}} ( π ) = \frac{{\sum }_{α = 1}^{K} N ( π , {c}_{α} , {c}_{j} )}{{\sum }_{β , γ = 1}^{K} N ( π , {c}_{β} , {c}_{γ} )} .$$

Again, this probability is converted into the needed channel transition probability by using an instance of multiplication rule:

$${P}_{j} ( π ) = \frac{{P}_{{c}_{J}} ( π )}{{n}_{t} ( {c}_{j} )} ,$$

Where, again, nₜ(cⱼ) is the number of channels that have shows that fall into category cⱼ at the end of the current time step.

In one embodiment of the invention, several or all of the categories will be programs themselves, given the finest level of granularity. In other instances, it is preferable to have broad categories to reduce the number of probabilities that need to be stored down.

2.3 Optimal Estimation with Markov Chain Observations

In the traditional filtering theory summarized above, one has that the observations are a distorted, corrupted partial measurement of the signal, according to a formula like

Yₖ=h(χₜ_{ₖ},Vₖ),

where tₖ is the observation time for the k^{th} observation and {Vₖ}ₖ₌₁⁰⁰ is some driving noise process, or some continuous time variant. However, for the DSTB model that we described in the immediately previous subsections, we have that Y is a discrete time Markov chain whose transition probabilities depend upon the signal. In this case, the new state Yₖ can depend upon its previous state, rendering the standard theory discussed above invalid. In this section, a new, analogous theory and system is presented for solving problems where the observations are a Markov chain. One noticeable generality of the system is that Markov chain observations may only be allowed to transition to a subset of all the states, a subset that depends on the state that the chain is currently in. This is a useful feature in the targeted advertising application, since much of the viewing queue's previous data may remain in the viewing queue after an observation and the insertion of some new data. For assimilation ease, this is described in the context of targeted advertisement even though it clearly applies in general.

Suppose that we have a Markov signal Xₜ with generator L and with an initial distribution v. Recall that the signal Xₜ evolves within the state space E. To be precise, the signal is defined to be the unique D_{E}{0, ∞) process that satisfies the (L, v)-martingale problem:

P(X₀,E,•)=v(•)

and

$${M}_{t} \dot{=} ϕ ( {X}_{t} ) - ϕ ( {X}_{0} ) - {\int }_{0}^{t} ℒϕ ( {X}_{x} ) d s$$

is a martingale for all φ ε D(L).

We wish to estimate the conditional distribution of Xₜ based upon {1,2, . . . , M}-valued discrete-time Markov chain observations that depends upon Xₜ as well as some exogenous information Dₜ. Recall that Yₖ=(yₖ, . . . y_{k-B+1}) with B representing the number of retained channel changes. To make things manifest, suppose that {vₖ}_{k=-∞}^{∞} is a sequence of independent random variables that are independent of the signal and observation such that

$$P ( {v}_{k} = i ) = \frac{1}{M}$$

for i=1, 2, . . . , M and k ε Z and that the observation \vec{y}ₖ occurs at time tₖ with finite state space {1, . . . , M} of events available, where yₖ=ᵥ_{ₖ}_{k=0,-1,-2,}^{\vec{y}}^{ₖ}^{=1,2,3, . . .} transitions between values in {1, . . . , M}^{B} with homogeneous transition probabilities p_{i→j}(Dₜ₁Xᵢ) of going from state i to state j at time t. Here, Dₜ and Xₜ are the current states of the pertinent exogenous information and signal states at the time of the possible state change.

To ease notation, we define Dₖ=Dₜ_{ₖ}ₜXₖ=Xₜ_{ₖ} and set

Vk=(uₖ₁uₖ₋₁ . . . , uk−B+1)^{T} for k=1,2, . . .

$${Z}_{j} \dot{=} \{ \begin{matrix}{\prod }_{k = 1}^{j} {ϛ}_{k}^{- 1} ( {X}_{k} ) & for j = 1 , 2 , … \\ 1 & for j = - 1 , - 2 , …\end{matrix} \\ and \\ {Z}_{t} \dot{=} {Z}_{j} for t ∈ ( {t}_{j} , {t}_{j + 1} ) ,$$

where

ζₖ(Xₖ)=M×pγₖ₋₁→γₖ(Dₖ,Xₖ).

Then, some mathematical calculations show that

$$E [ f ( {X}_{t} ) \vert σ \{ {Y}_{1} , … , {Y}_{j} \} ] = \frac{\overline{E} ⌊ f ( {X}_{t} ) {( Z ( T ) )}^{- 1} \vert σ \{ {Y}_{1} , … , {Y}_{j} \} ⌋}{\overline{E} [ {( Z ( T ) )}^{- 1} \vert σ \{ {Y}_{1} , … , {Y}_{j} \} ]} . \\ for {t}_{j} \leq T , \\ where f : E -> R and \\ \overline{P} ( A ) = E [ {1}_{A} Z ( T ) ] ∀ A ∈ σ \{ ( {X}_{t} , {Y}_{t} ) , t \leq T \} . \\ Letting \\ η ( t ) \dot{=} \frac{1}{Z ( t )} , \qquad ( 1 )$$

and noting the denominator and numerator of equation (1) above are both calculated from Ē[g(Xₜ)η(t)|]Fₜ^{γ}.
with g=1 and g=f respectively, where

$${F}_{t}^{γ} \mathring{=} σ \{ {Y}_{1} , … , {Y}_{j} \} for t ∈ [ {t}_{j} , {t}_{j + 1} ) ,$$

we just need an equation for

$${μ}_{t} f \dot{=} \overline{E} [ f ( {X}_{t} ) η ( t ) \vert {F}_{t}^{γ} ]$$

for a rich enough class of functions ƒ: E→R.

More mathematics establishes that

$${μ}_{t} ( d x ) \mathring{=} \overline{E} ( {1}_{{x}_{t} ∈ dx} ( t ) \vert {F}_{t}^{γ} ) satisfies$$

$${μ}_{t} ( ϕ ) - {μ}_{0} ( ϕ ) = {\int }_{0}^{t} {μ}_{s} ( ℒ ) d s + {\sum }_{k = 1}^{{n}_{t}} {μ}_{{t}_{k}} ( ϕ {\overline{ζ}}_{k} ) \\ for all t ∈ [ 0 , ∞ ) and ϕ ∈ D ( ℒ ) , \\ where {\overline{ζ}}_{k} ( x ) = 1 - \frac{1}{{ζ}_{k} ( x )} and {n}_{s} = max \{ k : {t}_{k} \leq s \} .$$

2.4 Filtering Approximations

In order to use the above derivation in a real-time computer system, approximations must be made so that the resulting equations can be implemented on the computer architecture. Different approximations must be made in order to use a particle filter or a discrete space filter. These approximations are highlighted in the sections below.

2.4.1 Particle Filter Approximation

By equation (1) we only need to approximate

$${μ}_{t} ( d s ) \dot{=} \overline{E} [ {1}_{{X}_{t}} ∈ d x η ( t ) \vert {F}_{t}^{γ} ] , \\ where \\ η ( t ) = {\prod }_{k = 1}^{⌊ t ⌋} M \times p {γ}_{k - 1} -> {γ}_{k} ( {D}_{k} , {X}_{k} ) = {\prod }_{k = 1}^{⌊ t ⌋} M \times p {γ}_{k - 1} -> {γ}_{k} ( {D}_{k} , {X}_{{t}_{k}} )$$

is the weighting function. Now, suppose that we introduce signal particles {ξₜⁱ≧0}ᵢ₌₁^{∞}, which evolve independently of each other, each with the same law as the historical signal, and define the weights

$${η}^{i} ( t ) = {\prod }_{k = 1}^{⌊ t ⌋} M \times p {γ}_{k - 1} -> {γ}_{k} ( {D}_{k} , {ξ}_{{t}_{k}}^{i} ) ,$$

Then, it follows by deFinnetti's theorem and the law of large numbers that

$$\frac{1}{N} {\sum }_{i = 1}^{N} {η}^{i} ( t ) {δ}_{{ξ}_{t}^{i}} ( d x ) ⇒ {μ}_{t} ( d x ) .$$

2.4.2 Discrete Space Approximation

If we can assume that the state space of E of Xₜ is a compact metric space, then for each N ε N, we let l_{N} and M_{N} satisfy l_{N}→∞ and M_{N}→∞ as M→∞. For D_{N}={1, . . . d_{N}} ⊂ N, we suppose that {Cₖ^{N}, k ε D_{N}} is a partition of E such that

$${max}_{k} diam ( {C}_{k}^{N} ) {}^{N -> ∞} 0 ,$$

and for large enough N that all the discrete state components are in different cells. Then, we take yₖ^{N} ε Cₖ^{N} and define

$${J}_{N} \dot{=} {\{ 0 , 1 , … , {M}_{N} \}}^{{d}_{N}} .$$

Take η(C^{N})=j to mean η(Cᵢ^{N})=ⱼⁱ for all i ε D_{N} and ηε M_{c}^{ƒ}(E). Then, the unnormalized distribution of the signal μₜ^{u} satisfies

$${μ}_{t} ( η ( {C}^{N} ) = j ) = {μ}_{0} ( η ( {C}^{N} ) = j ) + {\int }_{0}^{t} {μ}_{s} ( {ℒ}^{N} {1}_{η ( {C}^{N} ) = j} ) d s + {\sum }_{k = 1}^{{n}_{t}} {μ}_{tk} ( {1}_{\{ η ( {C}^{N} ) = j \}} {\overline{ζ}}_{k} )$$

where L^{N} is some discretized version of L. The application of REST then creates particle counts {Nₜ^{c,p}} for each cell in C^{N} and for each household population p within the cell-dependent set of allowable populations P_{c}^{N}, such that

$${μ}_{t}^{N} ( d x ) = {\sum }_{c ∈ {C}^{N}} {\sum }_{p ∈ {P}_{c}^{N}} {n}_{t}^{c , p} {δ}_{p , c} ( d x ) .$$

Then, it follows that

μₜ^{N}(dx) [symbol] μₜ(dx)

as N→∞ for each t≧0.

2.5 Refining Stochastic Grid Filter with Discrete Finite State Spaces

In U.S. Pat. No. 7,188,048, a general form of the REST filter was detailed. This method and system has demonstrated to be of use in several applications, particularly in Euclidean space tracking problems as well as discrete counting measure problems. However, several improvements upon this method have been discovered, which provide dramatic reductions in the memory and computational requirements for an embodiment of the invention. A new method and system for the REST filter is described herein where the signal can be modeled with a discrete and finite state space. Examples using the targeted advertising model are provided for clarity, but this method can be used with any problem that features the environment discussed below.

2.5.1 Environment Description

In certain problems, the signal is composed of zero or more targets Xₜⁱ and zero or more regimes Rₜ^{j}. For example, in targeted advertising one embodiment of the signal model is in the form χₜ=(Xₜ, Rₜ), where χₜ is the empirical measure of the targets (or, more specifically, the household members) and there is only one regime. Furthermore, each target and regime have only a discrete and finite number of states, and there are a finite number of targets and regimes (and consequently a finite number of possible combinations of targets and regimes). The finite number of combinations need not be all possible combinations—only a finite number of legitimate combinations are required. For instance, a finite number of possible types of households (meaning households that exhibit particular demographic compositions within) can be derived from geography-dependent census information at relatively granular levels. Instead of having all potential combinations of individuals (up to some maximum household membership n_{MAX}), only those combinations which can be possibly found within a given geographic region need to be considered legitimate and contained within the state space.

In these restricted problems, some components of the state of the target(s) and/or regime(s) may be invariant over the short period during which the optimal estimation is occurring. In these cases, such state information is held to be constant, while other portions of the state information remain variant. In one embodiment of the household signal model, the age, gender, income, and education levels of each individual within the household may be considered to be constant, as these values change over longer periods of time and the DSTB estimation occurs over a period of a few weeks. However, the current watching status and household regime information will change over relatively short time frames, and as a result these states are left to vary in the estimation problem. We shall denote the invariant portion of the signal as \hat{X} and the variant portion of the signal as \tilde{X}. There are N possible invariant states (the i^{th} such state donated by \hat{X}¹) and Mᵢ possible variant states for the i^{th} invariant state (the j^{th} state denoted by \tilde{X}^{i,j}).

2.5.2 REST Finite State Space System Overview

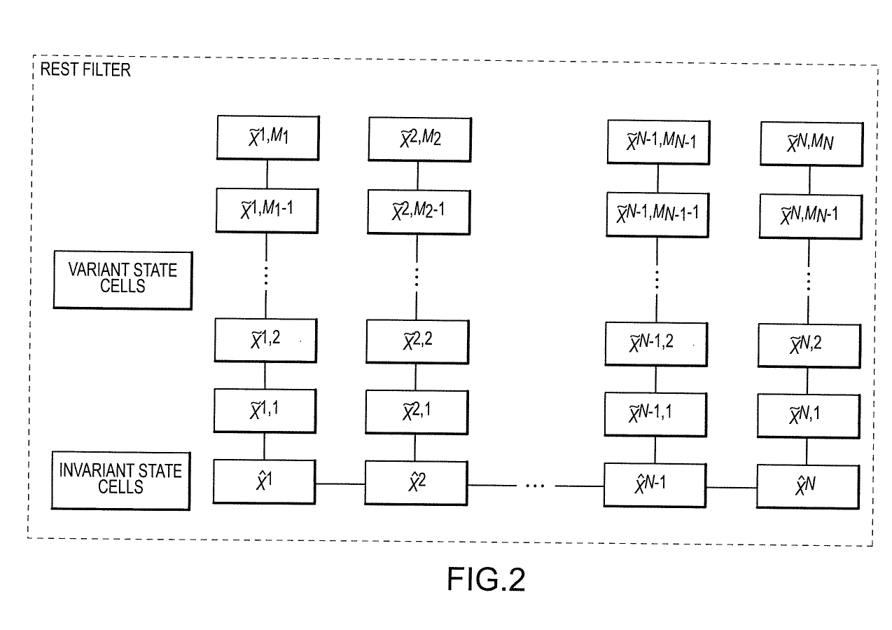

FIG. 2 depicts one preferred embodiment of the REST filter in a finite state space environment. REST is composed of a collection of invariant state cells, each of which represents one possible collection of targets and regimes for the signal along with their invariant state properties. Each invariant cell contains a collection of variant state cells, each representing the possible time-variant states of the given invariant cell. Implicitly, the variant cells contain the invariant state information of their parent invariant cell, meaning each variant cell represents a particular potential state of the signal. The invariant cells themselves represent an aggregate container object only and are used for convenience purposes. The collections of variant and invariant cells may be stored on a computer medium in the form of arrays, vectors, list or queues. Cells which have no particle count at a given time t may be removed from such containers to reduce space and computational requirements, although a mechanism to reinsert such cells at a later date is then necessary.

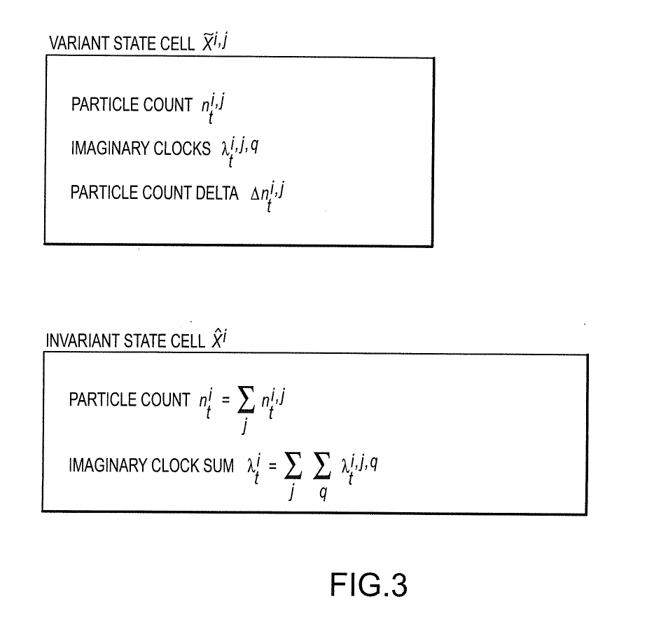

As shown in FIG. 3, each variant state sell contains a particle count nₜ^{i,j}. This particle count represents the discretized amplitude of that cell. As noted previously, this amplitude is used to calculate the conditional probability of a given state. Each variant state cell also contains a set of imaginary clocks λₜ^{i,j,q}. These imaginary clocks represent the time varying progression towards the event of a particle count change within a cell driven by both continuous transition rates and discrete observation events. For each variant state cell there are Q_{i,j} possible state transitions. In this environment, all valid state transitions occur within the same invariant state cell. To account for simultaneous changes in the conditional distribution of the REST filter, a temporary particle counter entitled particle count Δnₜ^{i,j} is used to store the number of particles that will be added or removed from the given variant state cell once the sequential processing of all cells is completed. Cells which have a valid state transition from the variant state cell with state \tilde{X}^{i,j} are said to be neighbors of that cell.

As mentioned above, the invariant state cells are containers used to simplify the processing of information. Each invariant state cell's particle count nₜⁱ is an aggregate of its child variant state cell particle counts. Similarly, the invariant state cell's imaginary time clock is an aggregation of all clocks from the variant cells. This aggregation facilitates the filter's evolution, as invariant states which have no current particle count can be skipped at various stages of processing.

2.5.3 REST Filter Evolution

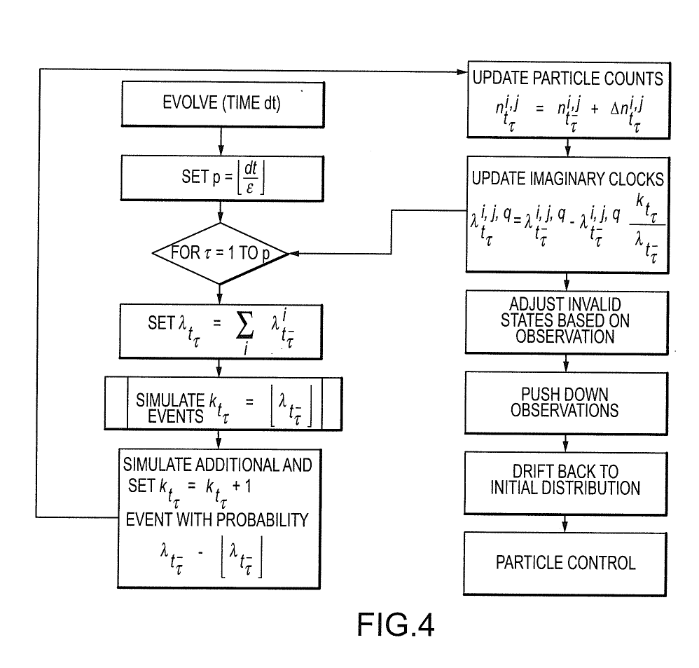

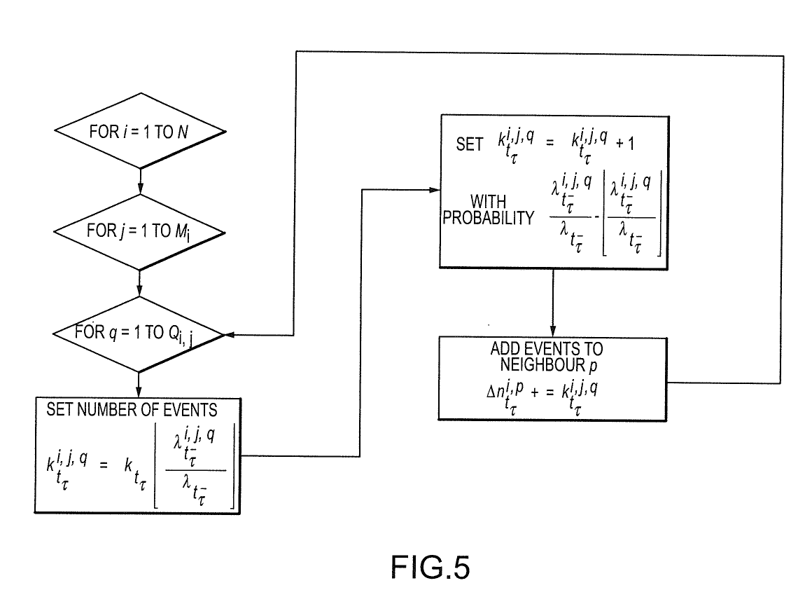

FIG. 4 depicts the typical evolution of the REST filter. This evolution method updates the conditional distribution of the filter over some time period Δt by transferring particles between neighboring cells using the imaginary clock values. The movement of a particle between neighboring cells is known as an event. (In practice, the movement of particles can be replaced with equivalent births and deaths to allow efficient cancellation of opposite rates.) Such events are simulated en masse to reduce the computational overhead of the evolution. The number of events to simulate is based on the total imaginary clock sum λₜ for all cells. FIG. 5 shows the method that determines how particles move to each neighboring cell. When the simulation of events is complete, the particle counts are updated and the imaginary clocks are scaled back to represent the change in the state of the filter.

Compared to the previous method described in U.S. Pat. No. 7,188,048, additional steps have been added to improve the effectiveness of the filter. Specifically, an adjustment to the cell particle counts now occurs prior to the push down observations method, and a drift back routine has been added prior to particle control. In certain problems, some cell states may have no possibility of being the current signal state based on observation information. For instance, a household must have a least one member currently watching if a channel change is recorded. In these circumstances, the particles in all invalid states must be redistributed proportionately to valid states. Thus, if there are nₜ^{invalid} particles to redistribute, then all valid variant state cells will receive

$$⌊ {n}_{t}^{invalid} \frac{{n}_{t}^{i , j}}{{\sum }_{i , j} {n}_{t}^{i , j}} ⌋$$

particles, and will receive an additional particle with probability

$${n}_{t}^{invalid} \frac{{n}_{t}^{i , j}}{{\sum }_{i , j} {n}_{t}^{i , j}} - ⌊ {n}_{t}^{invalid} \frac{{n}_{t}^{i , j}}{{\sum }_{i , j} {n}_{t}^{i , j}} ⌋ .$$

When this type of observation-based adjustment is used, it is likely that the rates governing the evolution of the signal must be appropriately altered to coincide with the use of observation data in this manner.

To improve the robustness of the REST filter, a drift back method has been added. This method uses some function ƒ(\tilde{X}^{i,j}, t) to add nₜ^{seed} particles to variant state cells based on the initial distribution v of the signal. The number of particles to add to each cell depends on time, the given cell, and the overall state of the filter. This method ensures that the filter does not converge to a small set of incorrect states without the ability to recover from an incorrect localization.

2.6 Head End Estimations

In order to maximize the profitability of multiple service operators' advertising operations, the determination of which commercials to distribute to a collection of DSTBs is critical. As more information is available about the actual viewership of commercials based on the conditional distributions (or conditional estimates derived thereof) of a DSTB-based asymptotically optimal nonlinear filter, the pricing of specific commercial slots can be more dynamic, thus improving overall profits.

To capitalize upon this potential, an estimate of the collection of household probability distributions, that includes such things as the number of people within each demographic, is performed at the Head End based on the whole set or a random sampling of conditional DSTB estimates. The following model contains a prefer embodiment of the Head End estimation system.

2.6.1 Head End Signal Model

The Head End signal model consists of pertinent trait information of potential and current television viewers that have DSTB, in communication with a particular Head End. A state space S is defined that represents such a collection of traits for a single individual. In one embodiment of the invention, this space could be made up of age ranges, gender, and recent viewing history for an individual. To keep track of individuals, we let C^{o}=0 be the household type of no individuals and Cⁿ be the collection of household types with n individuals

Cⁿ={((s₁n₁), . . . , (sᵣ,nᵣ)):sᵢεS and distinct, n₁+n₂+ . . . +nᵣ+n}.

The collection of households would then be the union

$${⋃}_{n = 0}^{∞} {C}^{n}$$

of the households with n people in them. Realistically, there would be a largest household N that we could handle and we set the household state space to be

$$E = {⋃}_{n = 0}^{N} {C}^{n} ,$$

where N is some large number.

To process the estimate transferred back from the DSTBs through the random sample mechanism, we also want to track the current channel for each DSTB. This means that each DSTB state; including potential household viewership, watching status, and current channel; is taken from

$$D \dot{=} E \times \{ 1 , 2 , … , M \} ,$$

where there is M possible channels that the DSTB could be tuned to.

We are not worried about a single DSTB nor even which DSTBs are in a particular state but rather with how many DSTBs are in state d ε D. Therefore, we let X, to be tracked, be a finite counting measure valued process, counting the number of DSTBs in each category d ε D over time. For technical reasons we define the signal to be either the probability distribution of X of the probability distributions of each component of X.

In an embodiment of the invention, it is possible to track in aggregate the possible number of DSTBs in each category to minimize the computational requirements. In such a case, elements of size o are used so that the total will still sum to the maximum number of DSTBs. For example, suppose that there are 1 million DSTBs. Then, we would have 100,000 elements (consisting of a=10 DSTBs each) distributed over D. Suppose M(D) denotes the counting measure on D and M̅(D) denotes the subset of M(D) that has exactly 100,000 elements. The signal will evolve mathematically according to a martingale problem

ƒ(Xₜ)=ƒ(X₀)+∫₀^{t}Lƒ(Xₛ)ds+Mₜ(ƒ),

where t→Mₜ(ƒ) is a martingale for each continuous, bounded functional ƒ on M̅(D) and L is some operator that would be determined largely from the DSTB rates and the natural assumption that the households act independently.

Any households that provide their demographics in exposed mode are not considered to be part of the signal.

2.6.2 Head End Observation Models

Herein we describe two observation models: one for the random sampling of DSTBs and one for delivery statistics.

For the random sample observation model, we consider the channel and viewership by letting X be our process as in the previous section, and let Vₖ denote the random selection at time tₖ in the sampling process. To be precise, suppose that there are M DSTBs for a particular Head End and suppose that a DSTB that believes at least one person is currently watching will supply a sample with a fixed probability of five percent. Then, Vₖ would be a matrix with a random number of rows, each row consisting of M entries with exactly one nonzero entry corresponding to the index of the particular DSTB which has provided a sample. The number rows would be the number of DSTBs providing a sample. The locations of the nonzero entries are naturally distinct over the rows and would be chosen uniformly over the possible permutations to reflect the actual sampling taken.

Now, we let (\hat{P}ₜ_{ₖ}, Uₖ) be the (column) vectors of the conditional distribution viewership estimates and corresponding channel changes of the M DSTBs, all at time tₖ. Then, this observation process would be

θₜ_{ₖ}¹=h(Vₖ•(\hat{P}ₖ,Uₖ)).

Here, the Vₖ would do the random selection and the h would be a function providing the information that is chosen to be communicated to the Head End.

For the aggregated ad delivery statistics model, we have time-indexed sequences of functions H_{k,j} that provide a count of the various ads delivered previously at time tₖ−tⱼ. There would be a small amount of noise W_{k,j} due to the fact that some DSTBs may not return any information due to temporary malfunction (i.e. a ‘missed observation’), and due to the fact that the estimated viewership used to determine a successful delivery is not guaranteed to be correct.

The second observation information from the aggregated delivery statistics would be

θₜ_{ₖ}^{2,j}=H_{k,j}(\hat{P}ₜ_{ₖ}₋ₜ_{ⱼ},W_{k,j}).

Here, j ranges back over the spot segments in the reporting periods and tₖ is the reporting period time.

2.6.3 Head End Filter

In a preferred embodiment of the invention, the signal for the Head End is taken to be a representation for the probability distributions from the DSTBs. This assignment can make the estimation problem more workable.

2.7 Head End Commercial Selection

In certain embodiments of the invention, other information may be available which also can be used to perform the aggregate viewership estimation. For example, aggregate (and possibly delayed) ad delivery statistics can also provide inferences in the estimated viewership of DSTBs, as well as any ‘exposed mode’ information whereby households opt to provide their state information (demographics, psychographics, etc.) in exchange for some compensation.

In this setting, commercial contract is modeled as a graph of incremental profit in terms of the contract details, available resources and future signal state. We call these graphs contract graphs which arrive with rates that depend upon the contract details, signal state and economic environments. Some of the contract details may include:

Number of times commercial is to be shown (could contain minimum and maximum thresholds), likely in thousands;

Time range for time of day/week that commercial is to be shown;

The Target demographic(s) for the commercial;

Particular channels or programs that the commercial is to be shown on; and

Customer that wrote the contract.

The random arrival of the contract graphs is denoted as the contract graph process. Furthermore, an allotment of resources (that need not be the maximum allotable to any contract) to a contract graph process is called a feasible selection if given the state (present and future) and the environment, the allotted resources do not exceed the available resources, i.e. the available commercial spots over the various categories. Now, due to the fact that these limited resource become depleted as one accepts contracts, current versus future potential profits are modeled through a utility function. This utility function takes the stream of contract graphs available (both presently and with future random arrivals) and returns a number indicating profit in terms of dollars or some other form of satisfaction. Due to the random future behavior of contract graphs, the utility function cannot simply provide maximum profits without taking into account deviation from the expected profit to ensure the maximization does not allow significant risk of poor profit.

To perform optimal commercial selection, the following models need to be defined: the Head End signal model, the Head End observation model, the contract generation model, and the utility (profit) model.

2.7.1 Contract Model

The commercial contracts that arise are modeled as a marked point process over the contract graphs. The rate of arrival for the contracts depends upon the previous contracts executed as well as external factors such as economic conditions.

Suppose that 1 denotes Lesbegue measure. Then, we let C denote the space of possible contract graphs with some topology on it, {ηₜ, t≧0} denote the counting measure stochastic process for the arrival of contract graphs up until time t and ξ denote a Poisson measure over C×[0, ∞)×[0, ∞) with some mean measure v×l×l. Furthermore, we let λ(c, η_{[0, t)}, t) be the rate (with respect to v) that a new contract will come with contract graph c ε C at time t when η_{[0,t)} the records the arrival of contract graphs from time 0 up to but not including time t. Then, we model contract arrival by the following stochastic differential equation”

nₜ(A)=η₀(A)+∫_{A×[0,∞)×[0,t]}1_{[0,λ(c,η}_{_{o,s}}_{,s))}(v)ξ(dc×dv×ds) for all A εB(C).

It is possible that the contract details noted above may be altered upon acceptance of a contract. As a result, the contract details are modeled to depend on an external environment which can evolve over time.

2.7.2 Utility Function Description

To ease notation, we let R(D_{S}) be the available resources, now and in the future, based upon the downloadable program information D_{S} at time s.

We will not be able to accept all contracts that arise and we have to make the decision whether to accept or reject a contract without looking into the future. We denote an admissible selection as a feasible selection such that each resource allocation decision does not use future contract or future observation information. In terms of the notation of the previous section, we suppose that nₜ represents the number of contracts that have arrived of the various types up to and including time t and take

γₜ(l)=∫_{Q}∫_{C×[0,t]}c(lₛ₋,Xₛ₋,q)η(dc×ds)dq for each t≧0,

where Q represents the set of all potential customers and {lₛ, s≧0} is a selection process, i.e., allocates resources to each contract c. Then, {lₛ, s≧0} is an admissible selection if lₛ≦R(D_{S}) for each s≧0 and lₛ does not use future contract or observation information, i.e., is measurable with respect to σ({ηᵤu≦s}, {θₜ_{ₖ}¹, θₜ_{ₖ}^{2,j}j ε N, tₖ≦s}) for each s≧0. Now, γₜ(l) represents the profit obtained up to time t through admissible selection l. To ease notation, we let λ be the set of all such admissible selections.

The utility function J balances current profit with future profit and the chance of obtaining very high profits on a particular contract with the risk of no or low profit. In order to ensure that we start off reasonably, we will deweight future profit in an exponential manner. Moreover, in order that we are not overly aggressive we will include a variance-like condition. One embodiment of the resulting utility function is

J(X,l)=∫_{[0,∞)}e^{-λt}[γₜ(l)−α(γₜ(l))²]dt,

for small constants λ, α>0. Then, the goal of the commercial selection process is to maximize E[J(X, l)] over the l ε λ. Such a goal can be solved using one or more asymptotically optimal filters.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1-32. (canceled)

33. A method for use in targeting assets to users of user equipment devices in a communications network, comprising the steps of:
developing an observation model based on first inputs by one or more users with respect to one or more user equipment devices;
developing a signal model reflective of the possible states and dynamics of a user composition of one or more users of a first user equipment device with respect to time, wherein said observation model probabilistically relates measurement data related to said first inputs to the possible states and dynamics;
employing a stochastic filter to estimate said user composition at a time of interest through an, approximate conditional distribution of a signal given the signal and observation models and second inputs by one or more users; and
using said estimated user composition in targeting an asset with respect to said user equipment device.

34. The method as set forth in claim 33, wherein said inputs are a click stream of user inputs over time and said observation model models said click stream as a Markov chain.

35. The method as set forth in claim 34, wherein said observation model takes into account programming related information for network content indicated by at least some of said inputs.

36. The method as set forth in claim 35, further comprising the step of processing said Markov chain using a mathematical model wherein observations of said Markov chain may only transition to a subset of a full set of states, where said subset depends on a current state of said Markov chain.

37. The method as set forth in claim 33, wherein said step of developing an observation model comprises modeling said observation model as a Markov chain or a k step Markov chain.

38. The method as set forth in claim 37, wherein the transition function for the observation Markov chain depends upon a position of the signal to estimate.

39. The method as set forth in claim 33, wherein said signal is established as representing said user composition and a separate factor affecting said user inputs.

40. The method as set forth in claim 33, wherein a model of said signal allows for representation of said user composition as including two or more users.

41. The method as set forth in claim 33, wherein a model of said signal allows for representation of a change in said user composition.

42. The method as set forth in claim 41, wherein said change is a change in a number of users associated with said user equipment device.

43. The method as set forth in claim 33, wherein said step of employing a stochastic filter comprises obtaining probabilistic estimates of said signal based on said observation model and measurement data.

44. The method as set forth in claim 43, wherein said step of employing a stochastic filter comprises defining a nonlinear filter to obtain probabilistic estimates of said signal based on said observation model and measurement data.

45. The method as set forth in claim 44, wherein said step of employing a stochastic filter further comprises establishing an approximation filter for approximating operation of said nonlinear filter.

46. The method as set forth in claim 45, wherein said approximation filter is a particle filter.

47. The method as set forth in claim 45, wherein said approximation filter is a discrete space filter.

48. The method as set forth in claim 33, wherein said step of using comprises providing information based on said user composition to a network platform operative to insert assets into a content stream of said network.

49. The method as set forth in claim 48, wherein said information identifies demographics of one or more users of said user equipment device.

50. The method as set forth in claim 49, wherein said platform is operative to aggregate user composition information associated with multiple user equipment devices and to select one or more assets for insertion based on said aggregated information.

51. The method as set forth in claim 48, wherein said platform is operative to process information from multiple user equipment devices as an observation model and to apply a filter with respect to said observation model to estimate an aggregate composition of a network audience at said time of interest.

52. The method as set forth in claim 49, wherein said platform is operative to select assets for insertion based on said aggregate composition and additional information affecting a delivery value of particular assets.

53. The method as set forth in claim 48, wherein said information identifies one or more appropriate assets for delivery to said user equipment device based on said user composition.

54. The method as set forth in claim 33, wherein said step of using comprises selecting, at said user equipment device, an asset for delivery to said one or more users.

55. The method as set forth in claim 33, wherein said step of using comprises reporting a goodness of fit of an asset delivered at said user equipment device with respect to said one or more users.

56. An apparatus for use in targeting assets to users of user equipment devices in a communications network, comprising:
a port operative for receiving input information regarding first inputs by one or more users with respect to a user equipment device; and
a processor operative for providing an observation model based on said first inputs, modeling the observation model as dependent upon a signal model reflective of at least a user composition of one or more users of said user equipment device with respect to time, where said observation model probabilistically relates measurement data related to said first inputs to said user composition, employing a stochastic filter to estimate the user composition at a time of interest as a state of a signal through an approximate conditional distribution of the signal given the signal and observation models and second inputs by one or more users, and using the estimated user composition in targeting an asset with respect to the user equipment device.

57. The apparatus as set forth in claim 56, wherein said processor is operative for defining a nonlinear filter to obtain estimates of said signal based on said observation model and measurement data.

58. The apparatus as set forth in claim 57, wherein said processor is operative for establishing an approximation filter for approximating operation of said nonlinear filter.

59. The apparatus as set forth in claim 58, wherein said nonlinear filter is one of a particle filter and a discrete space filter.

60. The apparatus as set forth in claim 56, further comprising a port for transmitting information for use in targeting assets to a separate network platform, wherein said information is based on said estimated user composition.

61. A method for use in targeting assets to users of user equipment devices in a broadcast network, comprising the steps of:
collectively analyzing a stream of data corresponding to a series of first user inputs with respect to one or more user equipment devices, wherein said step of collectively analyzing comprises establishing an observation model; and
applying logic for matching a pattern described by a stream corresponding to a series of second user inputs to a characteristic associated with an audience classification of a user, wherein said step of applying logic comprises employing a stochastic filter to approximately estimate the conditional distribution of a signal given the observation model and second inputs and extract signal estimates from said series of second user inputs to estimate said audience classification at a time of interest.

62. The method as set forth in claim 61, wherein said series of user inputs are modeled as a Markov chain.

63. The method as set forth in claim 61, wherein said step of applying logic comprises using a nonlinear filter model.

64. The method as set forth in claim 63, wherein said step of applying logic comprises executing an approximation filter to approximate operation of said nonlinear filter.
